(19) United States
(12) Patent Application Publication
(10) Pub. No.: US 2026/0134873 A1
(43) Pub. Date: May 14, 2026

(54) NOISE MONITORING METHOD, ELECTRONIC DEVICE AND STORAGE MEDIUM

(71) Applicant: HON HAI PRECISION INDUSTRY CO., LTD., New Taipei (TW)

(72) Inventors: YU-KAI ZHOU, New Taipei (TW); Chin-Pin Kuo, New Taipei (TW)

(21) Appl. No.: 19/259,347

(22) Filed: Jul. 3, 2025

(30) Foreign Application Priority Data
Nov. 11, 2024 (CN) 202411603274.X

(51) Int. Cl. G10L 19/02; G08B 21/18

(52) U.S. Cl. CPC G10L 19/0204; G08B 21/18

(57) ABSTRACT

The present application belongs to a computer technology field, and provides a noise monitoring method, an electronic device and a storage medium. The method includes obtaining noise data of a first time period. A spectrogram corresponding to the noise data is determined. Source information corresponding to the noise data is obtained according to the spectrogram through a first preset model. An warning threshold is determined according to the source information. A noise intensity of a second time period is predicted according to the noise data through a second preset model. Once the noise intensity of the second time period is greater than or equal to the warning threshold, an early warning is triggered. The method can trigger a noise alarm in time to prevent noise from affecting users.

### TECHNICAL FIELD

The present application relates to the field of computer technology, and in particular to a noise monitoring method, an electronic device and a storage medium.

### BACKGROUND

With an acceleration of urbanization, noise pollution issues such as traffic noise, construction noise, and industrial enterprise noise have become increasingly prominent. Noise pollution not only affects people's daily lives and work but may also harm their physical and mental health. Therefore, accurately monitoring noise has become an urgent problem to address.

Current noise monitoring methods often fail to trigger alarms in a timely manner. This results in users being unable to take corresponding measures promptly, negatively impacting user experience.

### BRIEF DESCRIPTION OF THE DRAWINGS

In order to more clearly illustrate technical solutions of embodiments of the present application, drawings required for use in the description of the embodiments of the present application will be briefly introduced below. Obviously, the drawings described below are only some embodiments of the present application. For the skilled in the art, other drawings can be obtained based on these drawings without paying creative labor.

FIG. 1 is a schematic diagram of a structure of an electronic device provided in an embodiment of the present application.

FIG. 2 is a flow chart of a noise monitoring method provided in an embodiment of the present application.

FIG. 3 is a flow chart of another noise monitoring method provided in an embodiment of the present application.

FIG. 4 is a flow chart of another noise monitoring method provided in an embodiment of the present application.

FIG. 5 is a diagram of functional modules of a noise monitoring apparatus provided in an embodiment of the present application.

### DETAILED DESCRIPTION

The following combines with the drawings in the embodiments of the present application to clearly and completely describe the technical solutions in the embodiments of the present application. Obviously, the described embodiments are part of the embodiments of the present application, not all of the embodiments. Based on the embodiments in the present application, all other embodiments obtained by the skilled in the art without creative work are within the scope of protection of this application.

In the following, the terms “first” and “second” are used for descriptive purposes only and should not be understood as indicating or implying relative importance or implicitly indicating the number of indicated technical features. Thus, the features defined as “first” and “second” may explicitly or implicitly include one or more of the features. In the description of the embodiments of the present application, words such as “exemplary” or “for example” are used to indicate examples, illustrations or explanations. Any embodiment or design described as “exemplary” or “for example” in the embodiments of the present application should not be interpreted as being more preferred or more advantageous than other embodiments or designs. Specifically, the use of words such as “exemplary” or “for example” is intended to present related concepts in a concrete way.

Unless otherwise defined, all technical and scientific terms used herein have the same meaning as those generally understood by technicians in the technical field in this application. The terms used in the specification of this application are only for the purpose of describing specific embodiments and are not intended to limit this application. It should be understood that, unless otherwise specified in this application, “/” means or. For example, A/B can represent A or B. “And/or” in this application is only a description of the association relationship of associated objects, indicating that three relationships can exist. For example, A and/or B can represent: A exists alone, A and B exist at the same time, and B exists alone. “At least one” means one or more. “a plurality of” means two or more than two. For example, at least one of “a”, “b” and “c” can represent seven situations: “a”, “b”, “c”, “a” and “b”, “a” and “c”, “b” and “c”, “a”, “b” and “c”.

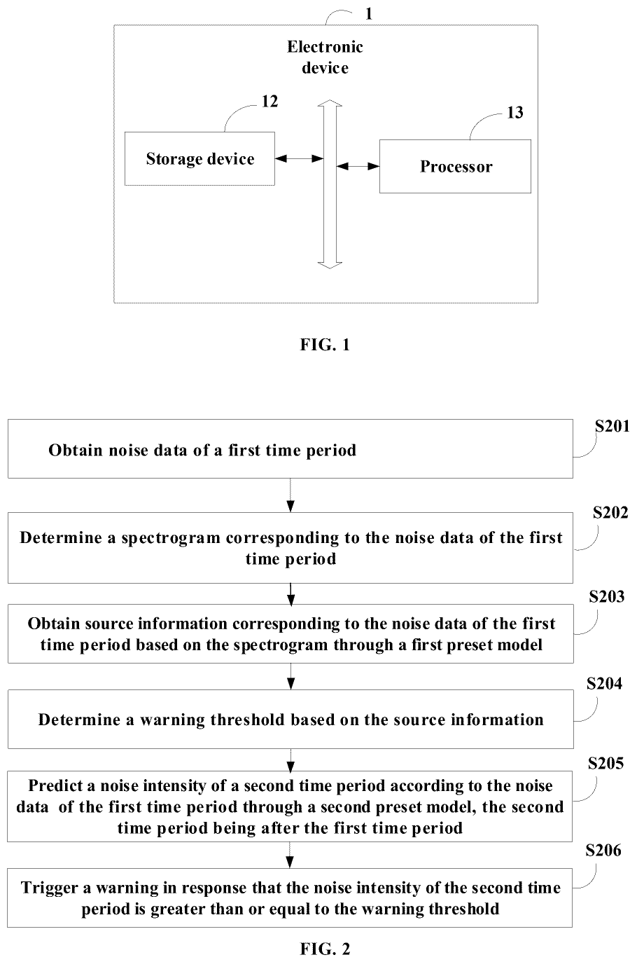

As shown in FIG. 1, it is a schematic diagram of a structure of an electronic device provided in an embodiment of the present application.

In an embodiment of the present application, a noise monitoring method is applied to one or more electronic devices 1, and each electronic device 1 is a device that can execute computer-readable instructions to automatically perform numerical calculations and/or information processing, and its hardware includes but is not limited to a microprocessor, an application specific integrated circuit (ASIC), a field-programmable gate array (FPGA), a digital signal processor (DSP), an embedded device, etc.

The electronic device 1 may be any electronic product that can perform human-computer interaction with a user, such as a personal computer, a tablet computer, a smart phone, a personal digital assistant (PDA), a game console, an internet protocol television (IPTV), a smart wearable device, etc.

The electronic device 1 may include a network device and/or a user device, where the network device includes but is not limited to a single network electronic device, an electronic device group including a plurality of network electronic devices, or a cloud including a large number of hosts or network electronic devices based on cloud computing.

The network where the electronic device 1 is located includes, but is not limited to: the Internet, a wide area network, a metropolitan area network, a local area network, a virtual private network (VPN), etc.

In the embodiment of the present application, the electronic device 1 includes, but is not limited to, a storage device 12, a processor 13, and computer-readable instructions stored in the storage device 12 and executable by the processor 13.

Those skilled in the art may understand that the schematic diagram is merely an example of the electronic device 1 and does not constitute a limitation on the electronic device 1. The electronic device 1 may include more or fewer components than shown in the figure, or a combination of certain components, or different components. For example, the electronic device 1 may also include input and output devices, network access devices, buses, etc.

The processor 13 may be a central processing unit (CPU), or other general-purpose processors, digital signal processors (DSP), application-specific integrated circuits (ASIC), field-programmable gate arrays (FPGA) or other programmable logic devices, discrete gate or transistor logic devices, discrete hardware components, etc. A general-purpose processor may be a microprocessor or a processor or any conventional processor, etc. The processor 13 is a computing core and a control center of the electronic device 1, and uses various interfaces and lines to connect various parts of the electronic device 1, and execute an operating system of the electronic device 1 and various installed applications, program codes, etc.

The storage device 12 may be an external storage device and/or an internal storage device of the electronic device 1. Furthermore, the storage device 12 may be a storage device in a physical form, such as a memory stick, a trans-flash (TF) card, and the like.

Referring to FIG. 2 to FIG. 4, the storage device 12 in the electronic device 1 stores computer-readable instructions, and the processor 13 can execute the computer-readable instructions stored in the storage device 12 to implement a plurality of processes shown in FIG. 2 to FIG. 4 to implement a noise monitoring method.

As shown in FIG. 2, it is a flow chart of the noise monitoring method provided in the embodiment of the present application. As shown in FIG. 2, the noise monitoring method in the embodiment of the present application includes steps S201-S206. According to different requirements, an order of steps in the flow chart can be changed, and some steps can be omitted.

S201, noise data of a first time period is obtained.

In at least one embodiment of the present application, the first time period can be set and adjusted according to actual needs. The first time period starts at a first time. For example, the first time period can be set to 9:00-9:10. That is, the first time period starts at 9:00. The electronic device obtains the noise data from the first time. The noise data can be a digital signal of audio. The noise data of the first time period can be noise data of any area. For example, the any area can be a noise area reported by a user, the noise area can be an area with noise problems, and the any area can also be an area with most noise problems in preset regions.

In at least one embodiment of the present application, the electronic device can be connected to a sound sensor for monitoring noise data, and the sound sensor can also be built into the electronic device. The sound sensor has a built-in condenser electret microphone. When sound waves act on the condenser electret microphone, an electret film of the condenser electret microphone will vibrate, thereby causing a change in capacitance and generating a voltage change corresponding to the capacitance. The voltage is amplified into an analog signal by a preamplifier in the sound sensor, and the analog signal is converted into a digital signal by an analog-to-digital converter in the sound sensor to obtain noise data.

This embodiment converts a sound wave signal into a digital signal that can be directly processed by the electronic device through internal components in the sound sensor, which can improve a data processing efficiency.

In some embodiments, the sound sensor has a built-in sensitivity adjustment button and a status indicator light. The sensitivity adjustment button can be used to adjust a sensitivity of the sound sensor. The status indicator light can be used to display a working status of the sound sensor, and the status indicator light can also be used to display a strength of the sound signal. The sound sensor supports a calibration function. For example, the user can adjust calibration parameters of the sound sensor through a software interface to adjust an impact of environmental factors on a performance of the sound sensor.

This embodiment can assist the user to timely learn the working status of the sound sensor and the strength of the sound signal through the status indicator light. The sensitivity of the sound sensor can be adjusted through the sensitivity adjustment button, and the calibration parameters of the sound sensor can be adjusted through the software interface, so that the sound sensor can adapt to different application scenarios, thereby improving a stability of collecting noise data.

In some embodiments, the noise data collected by the sound sensor is compressed to obtain compressed data, and the compressed data is encrypted to obtain encrypted data. The compressed data or the encrypted data is transmitted to a database and/or a cloud platform.

This embodiment can reduce a storage space occupied by the noise data and can reduce an amount of data transmission by compressing the noise data, thereby improving an efficiency of data transmission. By encrypting the compressed data, unauthorized tampering can be avoided, thereby ensuring an integrity and a confidentiality of the noise data. At the same time, since there is no need to directly encrypt the noise data, the encryption efficiency of the compressed data can be improved.

S202, a spectrogram corresponding to the noise data of the first time period is determined.

In at least one embodiment of the present application, determining the spectrogram corresponding to noise data of the first time period includes: obtaining a noise feature by performing a weighted processing on the noise data of the first time period based on a window function; obtaining spectral data by performing a Fourier transform on the noise feature, the spectral data including amplitude information of the noise feature at a preset frequency; and obtaining the spectrogram based on the preset frequency and the amplitude information corresponding to the preset frequency.

The window function may include a rectangular window, a Hamming window, a Hanning window, etc. The noise feature may include time domain information of the noise data, and the spectral data may include frequency domain information of the noise data. The preset frequency may be a frequency in the frequency domain information.

This embodiment can make an edge of signal truncation smooth by weighting the noise data. By performing the Fourier transform on the noise feature, the noise feature can be converted from the time domain to the frequency domain, which can provide a data basis for drawing a spectrogram. By obtaining the spectrogram, a frequency distribution and amplitude information of the signal can be displayed in a graphical way, which can make the analysis result more intuitive and easy to understand.

In some embodiments, obtaining the noise feature by performing the weighted processing on the noise data of the first time period based on the window function includes: generating a window function value array according to a preset window function type and a preset window function length, the window function value array including a window function value corresponding to each digital signal in a noise data segment. The noise data segment having a length same as the window function length is intercepted from the noise data. The noise feature is obtained by multiplying the window function value corresponding to each digital signal with each digital signal point by point.

Among them, the preset window function type may include a rectangular window type, a Hamming window type, a Hanning window type, etc., and the preset window function length may be set and adjusted according to actual needs. The window function value array may be calculated according to a window function formula corresponding to each of different window function types, and the window function value array includes the window function value corresponding to each digital signal in the noise data segment. For example, a formula of generating a Hamming window array may be:

$$w ( n ) = a - ( 1 - a ) cos ( \frac{2 Π n}{N - 1} ) ,$$

wherein, w(n) may represent a window function value corresponding to each digital signal in the noise data segment, a may represent any real number, a may be set and adjusted according to actual needs, n may represent a position of each digital signal in the noise data segment, n may be a value greater than or equal to zero and less than or equal to N−1, and N may represent the preset window function length.

For example, first 10 digital signals in noise data are [1, 2, 3, 4, 5, 6, 7, 8, 9, 10]. A Hamming window with a window function length of 5 is selected, and the generated window function value array can be [0.1, 0.5, 1.0, 0.5, 0.1]. A first noise data segment [1, 2, 3, 4, 5] with the same length as the window function is intercepted, and a point-by-point multiplication is performed to obtain a noise feature [0.1, 1.0, 3.0, 2.0, 0.5]. Continuing, a second noise data segment [3, 4, 5, 6, 7] with the same length as the window function is intercepted to obtain a second noise feature [0.3, 2.0, 5.0, 3.0, 0.7].

This embodiment can accurately reflect spectral characteristics of the audio data, reduce analysis errors, and intercept the audio segment with the same length as the window function, so as to ensure that the window function matches the noise data segment, thereby improving the calculation accuracy. By multiplying the generated window function value array with the corresponding sample value, the signal can be made smoother at the truncation point.

In some embodiments, obtaining the spectrogram based on the preset frequency and the amplitude information corresponding to the preset frequency includes: extracting amplitude information corresponding to different preset frequencies from the spectral data; using frequency as a horizontal axis and using amplitude as a vertical axis, obtaining the spectrogram by drawing a spectrum curve based on the preset frequency and the amplitude information.

This embodiment draws the spectrogram to intuitively display the distribution of noise data in the frequency domain in a graphical form, so that the electronic device can quickly identify the frequencies included in the noise data and the intensity corresponding to the frequencies, thereby improving processing efficiency.

S203, source information corresponding to the noise data of the first time period is obtained according to the spectrogram corresponding to the noise data through a first preset model.

In at least one embodiment of the present application, the first preset model may be a pre-trained deep learning model. Preset sources may include a construction site, a hospital, a car, a trade market, and the like.

In at least one embodiment of the present application, obtaining the source information corresponding to the noise data of the first time period according to the spectrogram corresponding to the noise data through the first preset model includes: obtain a first feature vector by encoding the spectrogram corresponding to the noise data through an encoding layer, and obtaining a second feature vector by encoding a spectrogram of each preset source; calculating a similarity between the first feature vector and each second feature vector through an output layer, and determining the preset source of which the spectrogram corresponding to a highest similarity as the source information.

This embodiment encodes the spectrogram to obtain the feature vector, and since there is no need to directly encode the noise data, the encoding efficiency can be improved. By calculating the similarity between the first feature vector and the second feature vector, since the feature vector can capture subtle differences between the noise data, the source information can be accurately determined.

In some embodiments, the coding layer includes a convolution layer, a first fully connected layer, and an activation layer. Obtaining the first feature vector by encoding the spectrogram corresponding to the noise data through the encoding layer includes: extracting local features in the spectrogram corresponding to the noise data through the convolution layer, performing a weighted operation on the local features based on a first weight matrix and a first bias term in the first fully connected layer to obtain weighted features, and a calculation formula of the weighted operation can be: z=Wx+b where Z can represent the weighted feature, W can represent the first weight matrix, x can represent the local feature, and b can represent the first bias term. A nonlinear transformation is performed on the weighted features based on an activation function of the activation layer to obtain the first feature vector.

This embodiment extracts the local features in the spectrogram through the convolution layer, and can effectively capture features at any position of the spectrogram. By weighting the local features through the first weight matrix and the first bias term, different local features can be combined, so that the information in the spectrogram can be fully analyzed. By using the activation function for the nonlinear transformation, a nonlinear relationship in the spectrogram can be captured, thereby improving the characterization accuracy of the first feature vector.

The second feature vector is obtained in a similar manner to the first feature vector, and will not be described again here.

In some embodiments, a process of calculating the similarity between the first feature vector and the second feature vector includes: calculating an Euclidean distance between the first feature vector and the second feature vector to obtain the similarity between the first feature vector and the second feature vector. A calculation formula of the similarity between the first feature vector and the second feature vector can be:

$$d = \sqrt{{\sum }_{i = 1}^{n} {( {a}_{i} - {b}_{i} )}^{2}} ,$$

where d can represent the similarity between the first feature vector and the second feature vector, n can represent a dimension of the first feature vector or the second feature vector, aᵢ can represent the i-th element of the first feature vector, and bᵢ represents the i-th element of the second feature vector.

In this embodiment, by calculating the similarity between the first feature vector and the second feature vector, the similarity does not need to be determined based on noise data, so the calculation efficiency of the similarity can be improved.

In other embodiments, obtaining the source information corresponding to the noise data of the first time period according to the spectrogram corresponding to the noise data through the first preset model further includes: constructing an index based on each preset source and the second feature vector corresponding to each preset source. The first feature vector corresponding to the noise data of the first time period is obtained using the encoding layer in the first preset model, the second feature vector similar to the first feature vector is queried and set as the third feature vector using the constructed index. A similarity score between the third feature vector and the first feature vector is calculated using the output layer in the first preset model, and the preset source corresponding to the third feature vector with a highest similarity score is determined as the source information.

The constructed index may be expressed in a form of a ball tree, a locality sensitive hashing, an approximate nearest neighbor search library, a K-dimensional space tree, etc.

This embodiment searches for the second feature vector similar to the first feature vector as the third feature vector. Since there is no need to perform a calculation and a comparison with the second feature vectors corresponding to all preset sources, an amount of similarity calculation can be reduced, thereby improving the efficiency of determining the source information.

S204, a warning threshold is determined based on the source information.

In at least one embodiment of the present application, determining the warning threshold according to the source information includes: determining the warning threshold based on preset conditions and source information. The preset conditions may include, but are not limited to: a noise type, an application scenario, device characteristics, user preferences, a frequency range of the noise, etc. For example, when the preset condition is the frequency range of the noise, if the frequency range is [0, 20 Hz], the warning threshold may set to be −10 dB; if the frequency range is [340 Hz, 350 Hz], the warning threshold may set to be −7 dB. This embodiment can more accurately monitor noise pollution by setting corresponding warning thresholds according to different conditions.

S205, a noise intensity of a second time period is predicted according to the noise data of the first time period using a second preset model.

In at least one embodiment of the present application, the second preset model includes an embedding layer and a prediction layer, and the embedding layer is used to encode time series data that is input to obtain a coding vector including key features in the noise data. The prediction layer is used to predict the noise intensity of the second time period based on the input noise data and set features in the prediction layer. The noise intensity of the second time period may include a noise decibel value, a noise level, etc. The second time period is after the first time period. Continuing with the above example, the first time period is 9:00-9:10, and the second time period can be 9:15-9:20. In one embodiment, the second time period starts at a second time, where the second time is later than the first time. In one embodiment, the first time period and the second time period do not overlap.

In at least one embodiment of the present application, based on the noise data of the first time period and noise data of a third time period, time series data is obtained, and the time series data is encoded using the embedding layer to obtain the coding vector. According to the coding vector, the noise intensity of the second time period is obtained using the prediction layer. The third time period occurs prior to the first time period.

The third time period occurs prior to the first time period. Continuing with the above example, the first time period is 9:00-9:10, and the third time period may be 1:00-8:00.

In this embodiment, the noise data of the first time period and the noise data of the third time period are used to construct time series data. The time series data can capture a long-term trend and periodic changes of the noise level. Since it does not only rely on a current noise analysis, a prediction accuracy of the noise intensity can be improved. By converting the time series data into the coding vector, the coding vector can capture important information and features about the noise data, so the prediction accuracy of the noise intensity can be improved.

In some embodiments, obtaining time series data includes: determining first intensities corresponding to the noise data of the first time period, determining second intensities corresponding to the noise data of the third time period, establishing a corresponding relationship between each timestamp in the first time period and the first intensity, and establishing a corresponding relationship between each timestamp in the third time period and the second intensity, to form a (timestamp, intensity value) pair. The (timestamp, intensity value) pairs are arranged in a chronological order to form the time series data. The timestamp is used to identify a collection time of each noise data.

This embodiment can establish a clear correspondence by matching the noise data with the corresponding timestamp, making data analysis more convenient. By arranging the (timestamp, intensity value) pairs in chronological order, an ordered data structure is formed, which can improve analysis efficiency.

In some embodiments, the embedding layer includes a preset embedding matrix, and obtaining the encoding vector may include: dividing time series into a plurality of time windows of a fixed length, and configuring a label for each time window. Based on the label corresponding to each time window, an embedding vector of a corresponding row is searched in the preset embedding matrix. A dimension of the embedding vector is equal to a number of columns of the preset embedding matrix. An average vector of the embedding vectors of all time windows is calculated as the encoding vector. Among them, a number of rows of the preset embedding matrix is equal to the number of time windows in the time series, and the number of columns of the preset embedding matrix is equal to the dimension of the embedding vector.

This embodiment divides the time series data into the windows of fixed length, so that the input data has a unified format, which is convenient for a batch processing and a parallel computing. Each time window is converted into the embedding vector using the preset embedding matrix. Since the embedding vector can capture similarities and differences between time windows, an accuracy of subsequent data can be improved.

In some embodiments, the prediction layer includes an output layer and a second fully connected layer, and obtaining the noise intensity of the second time period may include: inputting the encoding vector into the prediction layer, performing a weighted operation on the encoding vector based on the second weight matrix and the second bias term in the second fully connected layer to obtain a weighted result. Based on the weighted result, the weighted result output by the second fully connected layer is mapped to a single dimension of the output space by the output layer, to obtain the noise intensity of the second time period.

This embodiment can magnify or reduce the importance of features in time series data by performing weighted operations on the encoding vectors, thereby improving the representation accuracy of the weighted results.

In some embodiments, the electronic device may provide a display interface, convert the noise data of the first time period and the noise intensity of the second time period into a preset chart, and display the preset chart on the display interface, and the preset chart may include but is not limited to: a bar chart, a line chart, a pie chart, etc. This embodiment converts the noise data of the first time period and the noise intensity of the second time period into the preset chart, and displays the preset chart, so that the user can intuitively understand the noise level and the noise trend.

S206, a warning is triggered if the noise intensity of the second time period is greater than or equal to the warning threshold.

In at least one embodiment of the present application, the warning may include, but is not limited to: a sound alarm, an information alarm, and a visual alarm. For example, the sound alarm may be sounded through a speaker or an alarm bell. The information alarm may be an alarm message sent to relevant personnel via a mobile phone text message or email, and the alarm message may include the source of the noise, the noise intensity, and corresponding measures for dealing with different noises. The visual alarm may be an alarm issued through an indicator light or a screen display.

In this embodiment, the alarm is triggered by comparing the noise intensity of the second time period with the warning threshold. Since the second time period is after the first time period, the alarm can be issued in advance before the second time period arrives, and corresponding measures can be taken in time. In addition, the form of the warning can include multiple forms, so the effectiveness and coverage of the alarm can be improved.

In another embodiment, if the noise intensity of the second time period is less than the warning threshold, the sound sensor continuously monitors the noise data.

In the noise monitoring method of this embodiment, the noise data with the first time period is converted into the spectrogram and input into the first preset model for analysis. Since the first preset model does not need to directly analyze the noise data, the efficiency of determining the source information can be improved. Since the features corresponding to noises from different sources are different, the noise pollution can be accurately identified by comparing the noise intensity of the second time period with the warning threshold corresponding to the source information. In addition, when the noise intensity of the second time period is greater than or equal to the warning threshold, an early warning is triggered. Since the second time period is after the first time period, an alarm can be issued in advance before the second time period arrives, thereby avoiding the impact of noise on users and improving user experience.

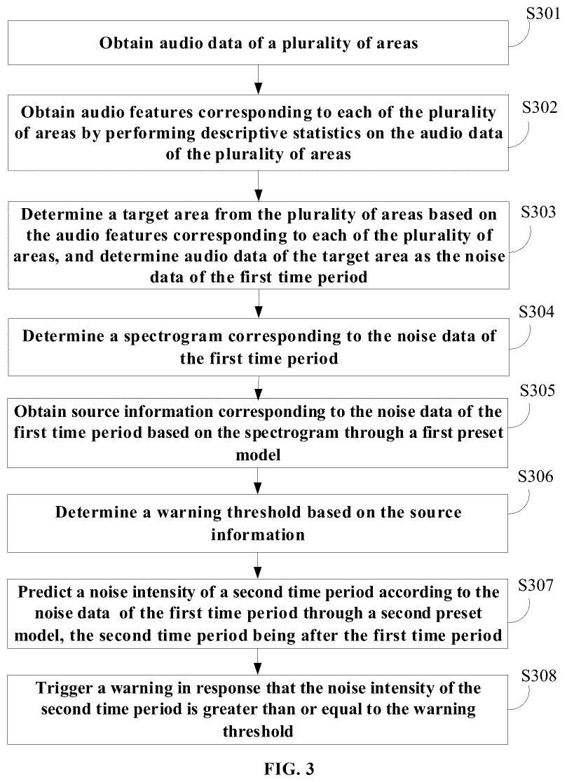

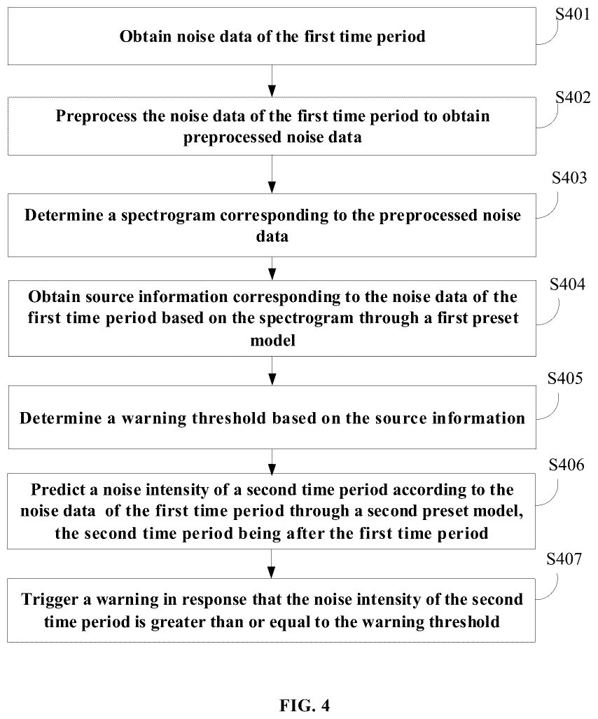

As shown in FIG. 3, another noise monitoring method provided by the embodiment of the present application includes steps S301-S308. According to different requirements, an order of the steps in the flow chart can be changed, and some steps can be omitted.

S301, audio data of a plurality of regions is acquired.

In at least one embodiment of the present application, the process in which the electronic device acquires audio data of the plurality of regions is similar to the process in which the electronic device acquires the noise data of the first time period, and is not described again here.

S302, audio features corresponding to each area are obtained by performing descriptive statistics on the audio data of the plurality of regions.

In at least one embodiment of the present application, the audio features corresponding to each area may include, but are not limited to: a mean value, a standard deviation, and a median of the sound intensities corresponding to the audio data of each area.

This embodiment can obtain the overall level and distribution trend of noise in each area by performing descriptive statistics on the audio data of the plurality of regions.

S303, a target area is determined based on the audio features corresponding to each area, and the audio data of the target area is determined as the noise data of a first time period.

In at least one embodiment of the present application, based on the audio features corresponding to each area and a preset threshold, first regions are screened, a data standard deviation of the audio data in each first area is determined, the first area with a maximum standard deviation value is determined as the target area, and the audio data of the target area is used as the noise data of the first time period. The threshold can be set and adjusted according to demand. The first area may include an area where the audio feature exceeds the set threshold.

This embodiment can preliminarily screen out the first area by setting a threshold. The area with the larger standard deviation value may indicate a larger noise level fluctuation. Therefore, through the data standard deviation of the audio data, the area with a larger noise level fluctuation can be accurately determined as the target area.

S304, a spectrogram corresponding to the noise data of the first time period is determined.

S305, source information corresponding to the noise data of the first time period is obtained according to the spectrogram corresponding to the noise data through a first preset model.

S306, a warning threshold is determined based on the source information.

S307, a noise intensity of the second time period is predicted according to the noise data of the first time period using a second preset model.

S308, a warning is triggered if the noise intensity of the second time period is greater than or equal to a warning threshold.

For details of steps S304-S308, please refer to the detailed description of steps S202-206 in FIG. 2 above, and will not be repeated here.

This embodiment can understand and evaluate the noise levels of different regions by performing descriptive statistics on the plurality of regions, so as to accurately determine the target area. Determining the area with the highest noise level as the target area and using the audio data of the target area as the noise data of the first time period can improve the effectiveness of noise monitoring.

As shown in FIG. 4, another noise monitoring method provided by the embodiment of the present application includes steps S401-S407. According to different requirements, an order of the steps in the flow chart can be changed, and some steps can be omitted.

S401, noise data of the first time period is obtained.

For details of step S401, please refer to the detailed description of step S201 in FIG. 2 above, and will not be repeated here.

S402, the noise data of the first time period is preprocessed to obtain preprocessed noise data.

In at least one embodiment of the present application, preprocessing the noise data of the first time period to obtain preprocessed noise data includes: cleaning the noise data of the first time period to obtain cleaned noise data, and normalizing the cleaned noise data to obtain preprocessed noise data.

This embodiment can remove erroneous data and duplicate data in the noise data by cleaning the noise data, thereby improving the overall quality and credibility of the cleaned noise data. By normalizing the cleaned noise data, since the normalized data has the same scale, the model processing efficiency can be improved.

In some embodiments, the process of cleaning the noise data of the first time period includes: performing descriptive statistics on the noise data of the first time period to obtain basic characteristics of the noise data of the first time period, and the basic characteristics include but are not limited to: a central trend (such as a mean, a median) of the noise data, a degree of dispersion (such as a standard deviation, a variance) of the noise data, a distribution shape (such as a skewness, a kurtosis) of the noise data, and abnormal values or extreme values in the noise data. Based on the basic characteristics of the noise data of the first time period, the abnormal data in the noise data of the first time period is identified. Based on the abnormal data, the corresponding method is selected for cleaning. For example, if duplicate values are identified in the data, the duplicate values are deleted; if missing values are identified in the data, the missing values are filled.

In this embodiment, by performing descriptive statistics on the audio data, the distribution of the data can be understood and the data quality can be evaluated, thereby identifying abnormal data for easy cleaning. Cleaning based on the identified data quality issues can improve the quality and reliability of the data.

In some embodiments, a process of normalizing the cleaned noise data includes: determining an amplitude value with a largest absolute value in the cleaned noise data as a target amplitude value. A normalization coefficient is obtained based on a ratio of a preset amplitude value to the absolute value of the target amplitude value. Each digital signal in the noise data is multiplied by the normalization coefficient to obtain the preprocessed noise data.

Among them, the preset amplitude value can be set and adjusted according to demand. For example, there is a noise data of [2, −5, 3, 8, −4, 0], and the amplitude value with the largest absolute value is determined as the target amplitude value, that is, the target amplitude value is 8. If the preset amplitude is set to 1, the ratio of the preset amplitude value to the absolute value of the target amplitude value is ⅛=0.125, and the normalization coefficient is 0.125. Each digital signal in the noise data is multiplied by the normalization coefficient. After calculation, the preprocessed noise data corresponding to the digital signal 2 is 0.125×2=0.5; the preprocessed noise data corresponding to the digital signal −5 is 0.125×(−5)=−0.625; the preprocessed noise data corresponding to the digital signal 3 is 0.125×3=0.375; the preprocessed noise data corresponding to the digital signal −4 is 0.125×(−4)=0.5; the preprocessed noise data corresponding to the digital signal 0 is 0.125×0=0; the final preprocessed noise data is [0.25, −0.625, 0.375, 1, 0.5, 0].

This embodiment can ensure a dynamic range of noise data by determining the amplitude value with the largest absolute value as a reference. By calculating a proportionality factor by the preset amplitude value and the absolute value of the target amplitude value, a suitable normalization coefficient can be calculated to ensure that all data values can be properly scaled. By multiplying the noise data with the normalization coefficient, the amplitude of the noise data can be adjusted to the same standard level, making the noise data easier to analyze.

S403, a spectrogram corresponding to the preprocessed noise data is determined.

In at least one embodiment of the present application, the manner in which the electronic device determines the spectrogram corresponding to the preprocessed noise data is similar to the manner in which the electronic device determines the spectrogram corresponding to the noise data of the first time period, and is not repeated here.

S404, source information corresponding to the noise data of the first time period is obtained according to the spectrogram corresponding to the noise data through a first preset model.

S405, a warning threshold is determined based on the source information.

S406, a noise intensity of a second time period is predicted according to the noise data of the first time period using a second preset model, where the second time period is after the first time period.

S407, a warning is triggered if the noise intensity of the second time period is greater than or equal to a warning threshold.

The details of steps S404-S407 can be found in the detailed description of steps S203-S206 in FIG. 2 above, and will not be repeated here.

This embodiment can remove the interference of abnormal data and improve data quality by cleaning the noise data of the first time period. By normalizing the cleaned noise data, the noise data can be adjusted to a specified interval, thereby improving the accuracy of the spectrogram.

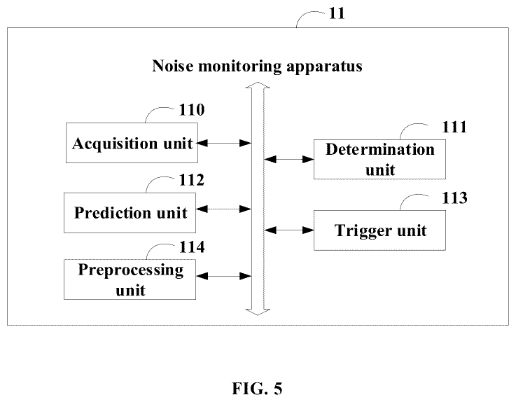

As shown in FIG. 5, it is a functional module diagram of a noise monitoring apparatus provided in an embodiment of the present application. The noise monitoring apparatus 11 includes an acquisition unit 110, a determination unit 111, a prediction unit 112, a trigger unit 113 and a preprocessing unit 114. The module/unit referred to in the present application refers to a series of computer-readable instruction segments that can be acquired by a processor (such as the processor 13 shown in FIG. 1) and can perform fixed functions, which are stored in a storage device (such as the storage device 12 shown in FIG. 1).

The acquisition unit 110 is used to acquire noise data of a first time period; the determination unit 111 is used to determine a spectrogram corresponding to the noise data of the first time period; the determination unit 111 is also used to obtain source information corresponding to the noise data of the first time period based on the spectrogram corresponding to the noise data through a first preset model; the determination unit 111 is also used to determine a warning threshold based on the source information; the prediction unit 112 is used to predict a noise intensity of a second time period according to the noise data of the first time period through a second preset model, and the second time period is after the first time period; the trigger unit 113 is used to trigger a warning if the noise intensity of the second time period is greater than or equal to the warning threshold.

In some embodiments, before obtaining the noise data of the first time period, the acquisition unit 110 is also used to obtain audio data of a plurality of regions; the determination unit 111 is also used to perform descriptive statistics on the audio data of the plurality of regions to obtain audio features corresponding to each area; the determination unit 111 is also used to determine a target area from the plurality of regions based on the audio features corresponding to each area, and determine the audio data of the target area as the noise data of the first time period.

In some embodiments, before obtaining the spectrogram, the preprocessing unit 114 is further used to preprocess the noise data of the first time period to obtain preprocessed noise data.

In some embodiments, the preprocessing unit 114 is specifically used to: clean the noise data of the first time period to obtain cleaned noise data; and normalize the cleaned noise data to obtain the preprocessed noise data.

In some embodiments, the determination unit 111 is specifically used to: perform a weighted processing on the noise data of the first time period based on a window function, to obtain a noise feature; perform a Fourier transform on the noise feature to obtain spectral data, the spectral data including amplitude information of the noise feature at a preset frequency; and obtain the spectrogram based on the preset frequency and the amplitude information corresponding to the preset frequency.

In some embodiments, the determination unit 111 is further specifically used to: encode the spectrogram corresponding to the noise data using an encoding layer to obtain a first feature vector, and encode a spectrogram of each preset source to obtain a second feature vector; calculate a similarity between the first feature vector and the second feature vector through an output layer, and determine the preset source corresponding to the spectrogram with the highest similarity as the source information.

In some embodiments, the determination unit 111 is further specifically configured to: determine the warning threshold based on preset conditions and the source information.

In some embodiments, the prediction unit 112 is specifically used to: obtain time series data based on the noise data of the first time period and the noise data of the third time period, where the third time period occurs prior to the first time period; encode the time series data through an embedding layer of the second preset model to obtain a coding vector; and obtain the noise intensity of the second time period according to the coding vector through a prediction layer of the second preset model.

By converting the noise data of the first time into a spectrogram and inputting it into the first preset model for analysis, since the first preset model does not need to directly analyze the noise data, the efficiency of determining the source information can be improved. Since the characteristics corresponding to noises from different sources are different, the noise pollution can be accurately identified by comparing the noise intensity of the second time period with the warning threshold corresponding to the source information. In addition, when the noise intensity of the second time period is greater than or equal to the warning threshold, an early warning is triggered. Since the second time period is after the first time period, an alarm can be issued in advance before the second time period arrives, thereby avoiding the impact of noise on users and improving user experience.

If the module/unit integrated in the electronic device 1 is implemented in the form of a software functional unit and sold or used as an independent product, it can be stored in a computer-readable storage medium. Based on this understanding, the present application implements all or part of the processes in the above-mentioned embodiment method, and can also instruct the relevant hardware to complete it through computer-readable instructions. The computer-readable instructions can be stored in a computer-readable storage medium, and when the computer-readable instructions are executed by the processor, the steps of the above-mentioned method embodiments can be implemented.

The computer-readable instructions include computer-readable instruction codes, which may be in form of source code, in form of object code, in form of executable files or some intermediate, etc. The computer-readable medium may include: any entity or device capable of carrying the computer-readable instruction codes, a recording medium, a USB flash drive, a mobile hard disk, a magnetic disk, an optical disk, a computer memory, a read-only memory (ROM), a random access memory (RAM).

Specifically, the specific implementation method of the processor 13 for the above-mentioned computer-readable instructions can refer to the description of the relevant steps in the corresponding embodiments of FIG. 2 to FIG. 4, which will not be repeated here.

In the several embodiments provided in this application, it should be understood that the disclosed systems, devices and methods can be implemented in other ways. For example, the device embodiments described above are only schematic, for example, the division of modules is only a logical function division, and there may be other division methods in actual implementation.

The modules described as separate components may or may not be physically separated, and the components shown as modules may or may not be physical units, that is, they may be located in one place or distributed on multiple network units. Some or all of the modules may be selected according to actual needs to achieve the purpose of the solution of this embodiment.

In addition, each functional module in each embodiment of the present application can be integrated into one processing unit, or each unit can exist physically separately, or two or more units can be integrated into one unit. The above-mentioned integrated unit can be implemented in the form of hardware or in the form of hardware plus software functional modules.

Therefore, no matter from which point of view, the embodiments should be regarded as illustrative and non-restrictive, and the scope of the present application is limited by the appended claims rather than the above description, so it is intended that all changes falling within the meaning and scope of the equivalent elements of the claims are included in the present application. Any attached figure mark in the claims should not be regarded as limiting the claims involved.

In addition, it is obvious that the word “comprising” does not exclude other units or steps, and the singular does not exclude the plural. Multiple units or devices can also be implemented by one unit or device through software or hardware. The words first, second, etc. are used to indicate names, and do not indicate any specific order.

Finally, it should be noted that the above embodiments are only used to illustrate the technical solution of the present application and are not intended to limit it. Although the present application has been described in detail with reference to the preferred embodiments, a person of ordinary skill in the art should understand that the technical solution of the present application may be modified or replaced by equivalents without departing from the spirit and scope of the technical solution of the present application.

What is claimed is:

1. A noise monitoring method, comprising:
obtaining noise data of a first time period;
determining a spectrogram corresponding to the noise data;
obtaining source information corresponding to the noise data based on the spectrogram by a first preset model;
determining a warning threshold based on the source information;
predicting a noise intensity of a second time period according to the noise data by a second preset model, wherein the first time period starts at a first time and the second time period starts at a second time, the second time is later than the first time, the first time period and the second time period do not overlap; and
triggering a warning in response that the noise intensity of the second time period is greater than or equal to the warning threshold.

2. The noise monitoring method according to claim 1, further comprising:
obtaining audio data of a plurality of regions;
obtaining audio features corresponding to each of the plurality of regions by performing descriptive statistics on the audio data of the plurality of regions; and
determining a target area from the plurality of regions based on the audio features corresponding to each of the plurality of regions, and determining audio data of the target area as the noise data of the first time period.

3. The noise monitoring method according to claim 1, wherein before determining the spectrogram corresponding to the noise data of the first time period, the method further comprises:
preprocessing the noise data of the first time period and obtaining preprocessed noise data.

4. The noise monitoring method according to claim 3, wherein preprocessing the noise data of the first time period and obtaining preprocessed noise data comprises:
cleaning the noise data of the first time period and obtaining cleaned noise data; and
normalizing the cleaned noise data and obtaining the preprocessed noise data.

5. The noise monitoring method according to claim 1, wherein determining the spectrogram corresponding to the noise data comprises:
performing a weighted processing on the noise data based on a window function, and obtaining a noise feature;
performing a Fourier transform on the noise feature and obtaining spectral data, wherein the spectral data comprises amplitude information of the noise feature at a preset frequency; and
obtaining the spectrogram based on the preset frequency and the amplitude information corresponding to the preset frequency.

6. The noise monitoring method according to claim 1, wherein the first preset model comprises an encoding layer and an output layer, and obtaining source information corresponding to the noise data based on the spectrogram through the first preset model comprises:
encoding the spectrogram corresponding to the noise data using the encoding layer and obtaining a first feature vector, and obtaining a second feature vector by encoding a spectrogram of each of preset sources;
calculating a similarity between the first feature vector and each second feature vector through the output layer, and
determining the preset source of which the spectrogram corresponding to a highest similarity as the source information.

7. The noise monitoring method according to claim 1, wherein determining the warning threshold according to the source information comprises:
determining the warning threshold based on preset conditions and the source information.

8. The noise monitoring method according to claim 1, wherein the second preset model comprises an embedding layer and a prediction layer, wherein predicting the noise intensity of the second time period according to the noise data through the second preset model comprises:
obtaining time series data based on the noise data of the first time period and noise data of a third time period, wherein the third time period occurs prior to the first time period;
encoding the time series data through the embedding layer and obtaining a coding vector; and
obtaining the noise intensity of the second time period according to the coding vector through the prediction layer.

9. An electronic device, comprising:
a storage device storing at least one instruction; and
at least one processor, when the at least one instruction is executed by the at least one processor, the at least one processor is caused to:
obtain noise data of a first time period;
determine a spectrogram corresponding to the noise data;
obtain source information corresponding to the noise data based on the spectrogram by a first preset model;
determine a warning threshold based on the source information;
predict a noise intensity of a second time period according to the noise data by a second preset model, wherein the first time period starts at a first time and the second time period starts at a second time, the second time is later than the first time, the first time period and the second time period do not overlap; and
trigger a warning in response that the noise intensity of the second time period is greater than or equal to the warning threshold.

10. The electronic device according to claim 9, wherein the at least one processor is further caused to:
obtain audio data of a plurality of regions;
obtain audio features corresponding to each of the plurality of regions by performing descriptive statistics on the audio data of the plurality of regions; and
determine a target area from the plurality of regions based on the audio features corresponding to each of the plurality of regions, and determine audio data of the target area as the noise data of the first time period.

11. The electronic device according to claim 9, wherein before determining the spectrogram corresponding to the noise data of the first time period, the at least one processor is further caused to:
preprocess the noise data of the first time period and obtain preprocessed noise data.

12. The electronic device according to claim 11, wherein the at least one processor preprocesses the noise data of the first time period and obtains preprocessed noise data by:
cleaning the noise data of the first time period and obtaining cleaned noise data; and
normalizing the cleaned noise data and obtaining the preprocessed noise data.

13. The electronic device according to claim 9, wherein the at least one processor determines the spectrogram corresponding to the noise data by:
performing a weighted processing on the noise data based on a window function, and obtaining a noise feature;
performing a Fourier transform on the noise feature and obtaining spectral data, wherein the spectral data comprises amplitude information of the noise feature at a preset frequency; and
obtaining the spectrogram based on the preset frequency and the amplitude information corresponding to the preset frequency.

14. The electronic device according to claim 9, wherein the first preset model comprises an encoding layer and an output layer, and the at least one processor obtains source information corresponding to the noise data based on the spectrogram through the first preset model by:
encoding the spectrogram corresponding to the noise data using the encoding layer and obtaining a first feature vector, and obtaining a second feature vector by encoding a spectrogram of each of preset sources;
calculating a similarity between the first feature vector and each second feature vector through the output layer, and
determining the preset source of which the spectrogram corresponding to a highest similarity as the source information.

15. The electronic device according to claim 9, wherein the at least one processor determines the warning threshold according to the source information by:
determining the warning threshold based on preset conditions and the source information.

16. The electronic device according to claim 9, wherein the second preset model comprises an embedding layer and a prediction layer, wherein the at least one processor predicts the noise intensity of the second time period according to the noise data through the second preset model by:
obtaining time series data based on the noise data of the first time period and noise data of a third time period, wherein the third time period occurs prior to the first time period;
encoding the time series data through the embedding layer and obtaining a coding vector; and
obtaining the noise intensity of the second time period according to the coding vector through the prediction layer.

17. A non-transitory storage medium, being stored with instructions, which when executed by a processor, causing the processor performs a noise monitoring method, wherein the method comprises:
obtaining noise data of a first time period;
determining a spectrogram corresponding to the noise data;
obtaining source information corresponding to the noise data based on the spectrogram by a first preset model;
determining a warning threshold based on the source information;
predicting a noise intensity of a second time period according to the noise data by a second preset model, wherein the first time period starts at a first time and the second time period starts at a second time, the second time is later than the first time, the first time period and the second time period do not overlap; and
triggering a warning in response that the noise intensity of the second time period is greater than or equal to the warning threshold.

18. The non-transitory storage medium according to claim 17, wherein the method further comprises:
obtaining audio data of a plurality of regions;
obtaining audio features corresponding to each of the plurality of regions by performing descriptive statistics on the audio data of the plurality of regions; and
determining a target area from the plurality of regions based on the audio features corresponding to each of the plurality of regions, and determining audio data of the target area as the noise data of the first time period.

19. The non-transitory storage medium according to claim 17, wherein before determining the spectrogram corresponding to the noise data of the first time period, the method further comprises:
preprocessing the noise data of the first time period and obtaining preprocessed noise data.

20. The non-transitory storage medium according to claim 19, wherein preprocessing the noise data of the first time period and obtaining preprocessed noise data comprises:
cleaning the noise data of the first time period and obtaining cleaned noise data; and
normalizing the cleaned noise data and obtaining the preprocessed noise data.
